(19) United States
(12) Patent Application Publication
(10) Pub. No.: US 2007/0102484 A1
(43) Pub. Date: May 10, 2007

(54) ANGLED CAULKING TIP ATTACHMENT

(76) Inventor: Don BALDWIN, Hood River, OR (US)

Correspondence Address: PATENTTM.US, P. O. BOX 82788, PORTLAND, OR, 97282-0788, US

(21) Appl. No.: 11/538,051

(22) Filed: Oct. 2, 2006

Related U.S. Application Data
(60) Provisional application No. 60/735,348, filed on Nov. 10, 2005.

(51) Int. Cl. A47J 36/02

(52) U.S. Cl. 228/101

(57) ABSTRACT

A tip attachment for use in dispensing products from tubes or squeeze bottles, such as caulking, sealants, adhesives, lubricants or the like. An elongate tip attaches to a threaded base member, the threaded base member adapted for engagement with a standard straight tip of the product tube. The tip is suitable angled, providing the ability to apply the product into a variety of locations that might otherwise not be reachable with the standard straight tip.

### BACKGROUND OF THE INVENTION

This invention relates to caulking devices and the like, and more particularly to an attachment for use as the tip for a caulking tube, glue tube, lubricant tube or other material application device.

Typically, there is some type of caulking or sealing to be done within the various phases of building, construction, home repair and hobbies. Sealants, glues, lubricants, cleaners, etc. for such uses are supplied in a squeeze/push type tube/bottle, containing products intended for use or one times. The product is traditionally been delivered using a standard straight tip at the end of the tube. The tube is purchased and stored with the tip closed, and at first use, the tip is cut to allow the product to be dispensed by squeezing of the tube. Typically, in the case of caulking, the product tube end opposite the tip has a piston or ram member that is adapted to be driven into the tube by a calking gun so as to force the product out the tip end of the tube.

Often the spaces or location needing product are difficult to access and proper application of the caulking/sealant product is difficult with the standard straight tip.

In an attempt to overcome some of these difficulties, attachment tips for replacing the standard tip have been devised. Many of these, however, require a customized attachment to the product tube. For example, U.S. Pat. No. 5,249,716 envisions an attaching nut to attach an angled guide tube to the product tube, and then a dispensing tube is inserted into the angled guide tube, providing an angled dispensing feature.

Other tips are secured by positioning in the caulking gun prior to placement of the product tube therein. See, for example, U.S. Pat. No. D468,601, where a circular flange portion is provided to secure the tip relative to the caulking gun. This type of configuration is more difficult to change or replace, and is harder to clean.

U.S. Pat. No. 6,076,712 shows a flexible caulk tube nozzle for attaching to the standard straight tip. An accordion flexible portion of the tip allows it to be adjusted to an angle. A concern, however, is that in use, the according portion may be likely to shift position if the tip is bumped or if sufficient pressure is applied to the end of the tip against the application site when dispensing product through the tip. Further, more viscous products are likely to be dispensed under higher pressure, and would be more likely to cause the accordion portion to return to the straight position when attempting to dispense.

### SUMMARY OF THE INVENTION

In accordance with the invention, a screw on caulking tip attachment is provided, which may be angled, adapted for placement over the standard straight tip of a caulking or other product tube. The tip suitably includes an interior thread portion having sharp cutting threads, for engagement with the outer surface of a standard straight tip of a caulk tube or the like.

Accordingly, it is an object of the present invention to provide an improved add on tip for a product dispensing tube.

It is a further object of the present invention to provide an improved angled tip that is adapted to thread onto a standard product dispensing tube tip and provide a removable dispensing tip.

It is yet another object of the present invention to provide an improved angled dispensing tip attachment adapted for multiple such tips to be attached together to provide an even greater angle dispensing tip or complex tip angles.

It is another object of the invention to provide an improved dispensing tip that is re-usable.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a side view of the tip attachment in accordance with the invention;

FIG. 2 is a second side view of the tip attachment, viewed from an axis 90 degrees from the view of FIG. 1;

FIG. 3 is an exploded sectional view of the tip attachment, taken along line 3-3 of FIG. 1;

FIG. 4 is a bottom view of the tip portion of FIG. 3;

FIG. 5 is a top view of the base of FIG. 3;

FIG. 6 is a bottom view of the assembled tip attachment;

FIG. 7 is an environmental view with the tip attachment installed on a caulking tube;

FIG. 8 is a side view of the tip attachment in accordance with the invention, illustrating the tip portion thereof having been cut for use;

FIG. 9 and FIG. 10 are front and side views of a square tip adapted for glazing;

FIG. 11 and FIG. 12 are front and side views of a glue tip or flashing tip;

FIG. 13 and FIG. 14 are front and side views of a corner tip;

FIG. 15 and FIG. 16 are front and side views of a grouting tip or flashing tip;

FIG. 17 and FIG. 18 are front and side views of a long tip adapted for utility uses;

FIG. 19 and FIG. 20 are front and side views of a siding tip having a toe guide;

FIG. 21 and FIG. 22 are front and side views of a super glue tip;

FIG. 23 and FIG. 24 are front and side views of a dome tip; and

FIG. 25 and FIG. 26 are front and side views of an angled tip.

### DETAILED DESCRIPTION

The tip attachment according to a preferred embodiment of the present invention comprises a curved tip portion and a threaded engagement portion for attachment to a standard straight tip of a product tube, such as a caulking tube or the like.

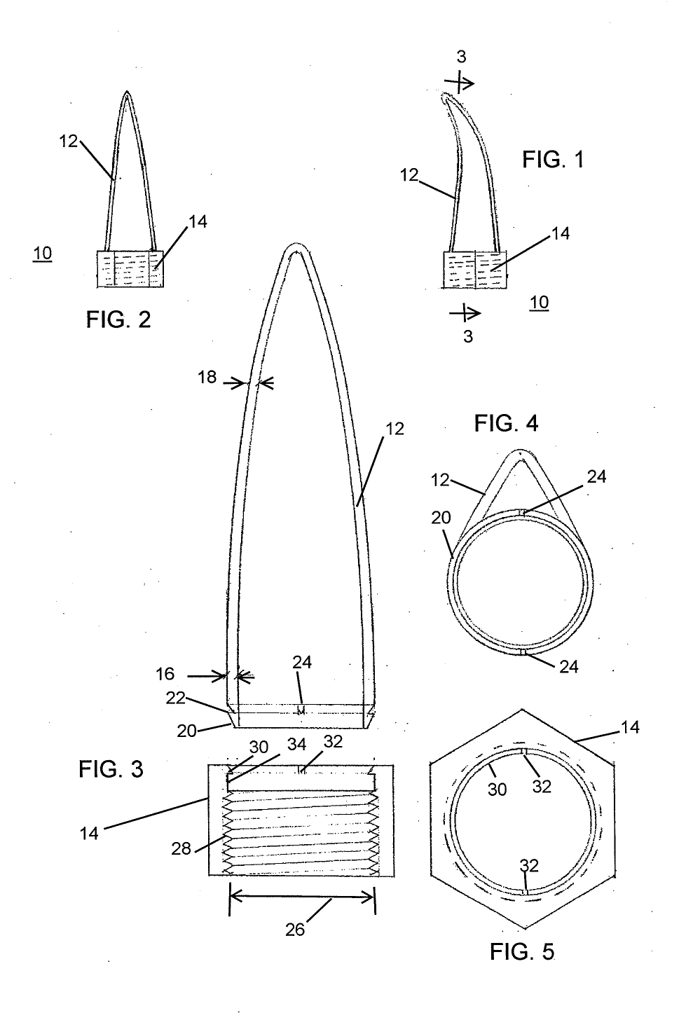

Referring to FIGS. 1 and 2, which are side views of the tip attachment 10, FIG. 1 being a first side view and FIG. 2 being a second side view rotated 90 degrees. The tip attachment 10 comprises an elongate angled tip portion 12, attached to a base member 14. Base member 14 is suitably hex shaped on its exterior.

Referring to FIG. 3, an exploded sectional view of the tip attachment 10, taken along line 3-3 of FIG. 1, and FIG. 4, a bottom view of the tip portion of FIG. 3, it may be observed that the interior of the tip portion 12 is generally hollow and is slightly thicker at the base portion than at the upper portions thereof. A suitable thickness at location 16 is 0.0625 inches, while at location 18, is 0.0468 inches. The base of tip portion 12 is substantially circular in cross section as may be observed in FIG. 4, a bottom view of the tip portion.

At the base of tip portion 12, a short tapered region 20 is provided, being narrowest at the very bottom and extending outwardly as we move up the length of the tip portion. A circumferential notch 22 is defined around the periphery of the top of the tapered region 20. A protruding tab portion 24 is defined at a portion of the notch opposing sides of the base, thereby providing 2 such tabs 24 (as is seen in FIG. 4).

Referring still to FIG. 3 and to FIG. 5, a top view of the base portion 14 of FIG. 3, the base has a substantially circular interior portion having a diameter 26 of 0.4687 inches. Threads 28 are formed in the interior face of the base from the bottom of the base portion up about 75% of the overall height of the base. The preferred depth 28 of the threads is 3/64 (0.0468) inch, and they are suitably sharp edge cutting threads that operate in a manner corresponding to a cutting die. The base 14 has an inwardly extending interior circumferential notch 30, having a taper of corresponding shape to the shape of the taper portion of notch 22 in the tip portion 12. A slot 32 is defined at opposite sides of the upper edge of the base 14, having a shape corresponding to the shape of tab 24. There are 2 such slots 32, positioned 180 degrees from each other around the interior circumference of the base 14.

A circumferential slot 34 is defined about the interior of the base 14, below the notch 30 and above the threaded portion 28.

It may be observed in FIG. 5, that the exterior walls of the base 14 are in the form of a hexagon nut, in the illustrated embodiment.

The two portions portion 12 with the taper 20, notches 22, tabs 24 and portion 14, with the notch 30, tab 32 and slot 34 cooperate such that the tip attachment 10 is assembled by snapping the two portions 12 and 14 together, whereby the tip and base are held together for use. A purpose of the tabs 24 and notches 30 is to prevent the tip portion from spinning relative to the base.

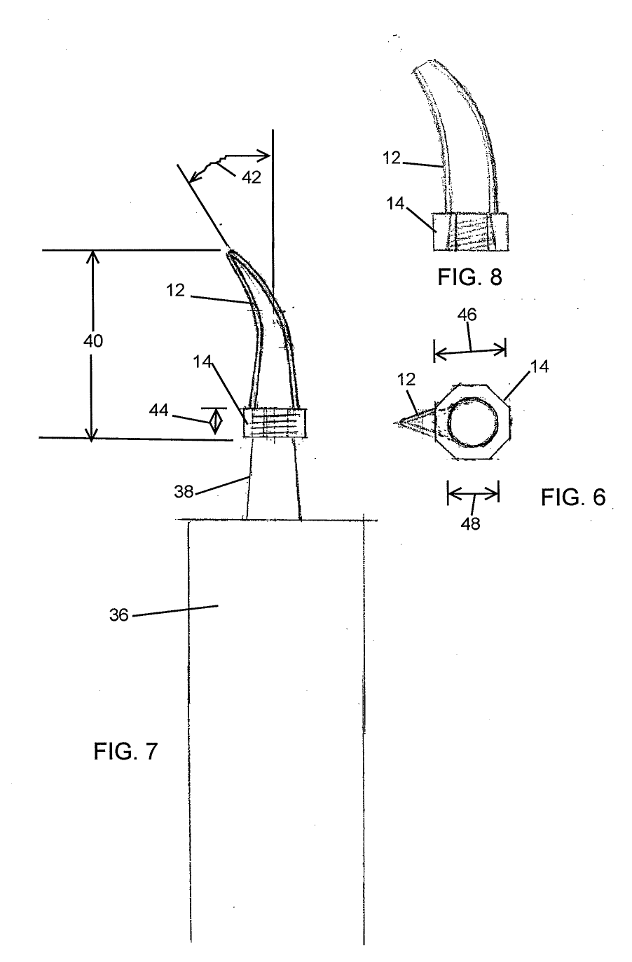

Referring now to FIG. 6, a bottom view of the assembled tip attachment, in a particular embodiment, the overall diameter 46 of the base portion is ⅝ inch (1.6 cm), while an individual face length 48 of the hex shape is 7/16 inch (1.125 cm).

Referring now to FIG. 7, an environmental view with the tip attachment installed on a caulking tube 36, the tube has a standard straight tip 38 at the dispensing end thereof. In use, a top portion of the standard straight tip is cut off, and the attachment tip of the present invention is placed thereover. The base 14 is grasped (whether by hand or by use of a tool) and rotated, such that the threads 28 will bite into the material of the standard straight tip and securely engage the attachment tip thereto. Typically 1 to 1.5 turns is suitable for sufficient engagement. The peripheral end of the tip portion 12 may then be cut (or it can be cut before installing) to provide an opening of a desired side, and the user may then begin to dispense and apply the caulk or whatever other material is in the caulking tube 36. FIG. 8 is a side view of the tip attachment in accordance with the invention, illustrating the tip portion thereof having been cut for use to apply material from the caulking tube.

Threads 28 are suitably formed as sharp cutting threads, to provide the most desirable engagement with the standard straight tip.

The tip attachment is also suitably used as a removable cap for a standard straight tip, by employing the tip attachment in the uncut configuration, as in FIG. 7.

Another advantage to the attachment time in accordance with the invention is that if caulking (or whatever material is in the tube 36) dries in the tip, the tip may be removed and easily cleaned out for reuse. This is advantageous in that typically the dried material will be only in the tip attachment, and material therebelow in the standard straight tip will likely remain uncured, so that the entire tube won't be wasted as a result of the material drying in the standard straight tip, as was the case heretofore.

A typical angle of the tip attachment in the preferred embodiments is 25 to 30 degrees. Multiple ones of the tip attachment may be employed by attaching subsequent tip attachments to one another, (the base 14′ of a second attachment 10′ being screwed onto a first tip portion 12, etc.) enabling a more pronounced curve, or a compound curve, with one or more second tips oriented in a different direction to provide differing tip inflections (concave up, down, etc.), by adjusting the orientation of the tip portions, to enable application of caulking or the like to hard to reach places.

The overall length 40 (FIG. 7) of the preferred embodiment tip attachment 10 is approximately 2 inches. As noted above, the base width is suitable ⅝ inches. The tip portion 12 comprises a tapered hollow cone shaped cylinder angled at an angle 42 of approximately 25 to 30 degrees. The threads inside base 14 are suitably 15/32 inch threads with a depth of 3/64 inch. Also, alternate threads are 7/16-14 threads with the depths noted in connection with the drawings. The tip portion 12 is suitably made of polyethylene, polypropylene, PAVC, nylon, ABS, or a polyblend or the like. The base 14 has a height 44 of ⅜ inch and is also suitably made of the above noted materials, and further may be a metal, such as brass, etc. The base 14 can also suitable be molded out of a glass filed Nylon or Delran. It is preferred to have the base portion be of sufficiently hard material to provide sharp cutting threads.

While caulking is employed herein as the typical example, other materials such as sealant, lubricants, glues and other materials provided in tubes or squeeze bottles and the like are suitable for use with the tip attachment described herein.

In manufacturing the tip attachment in accordance with the present invention, it is suitable made as two separate parts as shown in FIG. 3, tip 12 and base 14. The manufacture of both may be accomplished by molding, with the threads being added as a post molding step if necessary. In the case where the base portion is not made of a moldable material (e.g. when made of metal), different manufacturing steps would be employed to construct that portion, with post threading step if desired or necessary. The two pieces 12 and 14 are then snap assembled. This two piece construction enables multiple tip styles beyond the illustrated tip to be made, while employing the same base style 14. Also, different size bases 14 can be employed, adapted to fit different size standard straight tips, while enabling use of the various tips 12 without having to make those of different size. This is accomplished by configuring the other size base members 14 so that the portions thereof that interact with the tip are of the size illustrated, while the other end of the base and corresponding threads can be modified to fit other uses.

In an alternative embodiment, instead of the snap joining configuration, the two parts may be molded together, or formed separately and glued or otherwise permanently fastened together.

Other tip configurations may include triangular cross section rather than circular, or square or flat/rectangular, for example. A flat tip is suitable for effectively reaching underneath flashing, for dispensing of material thereunder.

Other tip end shapes can be v-shaped, dome shaped, chisel shaped, double taper in addition to the standard round. The tip 12 illustrated is initially provided with a closed end to allow the user to cut to desired shape, but any of the tips may be provided with a hole or opening in the end thereof. A suitable initial opening size is ⅛ inch.

While the illustrated tip length is 2 inches, other lengths may be provided as desired for different applications.

The base may be changed also, to conform to other uses requiring different thread configuration and base sizes.

The product may be provided with a color to indicate different sizes or uses, for example, different colors for different thread sizes in base 14. Tips more adapted for dispensing certain materials (e.g. less likely to be permanently adhered to by specific materials being dispensed) may be given a different color than other tip types.

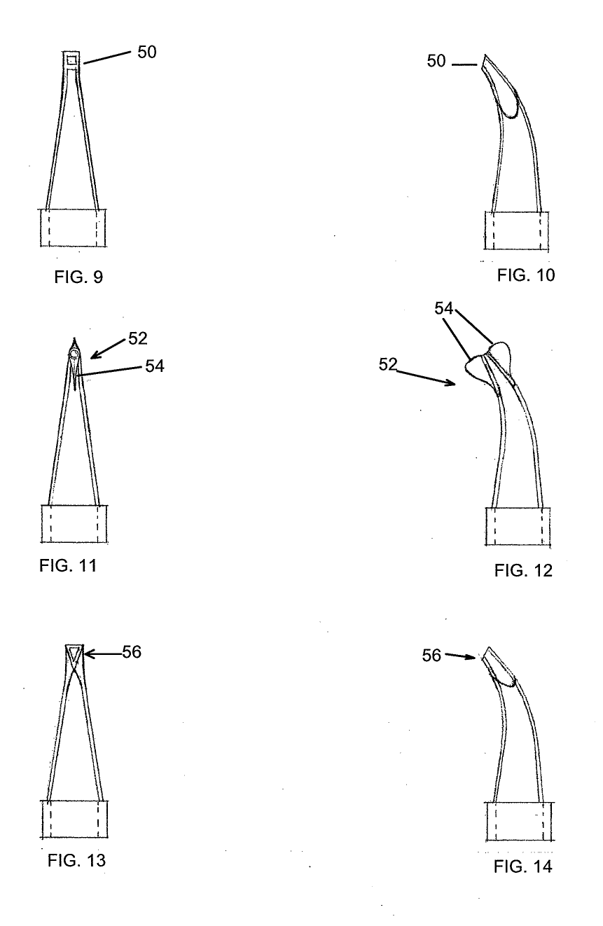

Suitable examples of variations of tip configurations are shown in connection with FIGS. 9-26.

FIG. 9 and FIG. 10 are front and side views of a square tip adapted for glazing, for example. The tip 50 suitably forms a square opening, and is molded to this open configuration, not needing to be cut open for initial use.

FIG. 11 and FIG. 12 are front and side views of a glue tip or flashing tip 52, wherein flared wing portions 54 are provided. The opening of the tip is suitably round or oval, and is molded to the open configuration, not needing to be cut unless desired by the user for modification thereof.

FIG. 13 and FIG. 14 are front and side views of a corner tip, having a molded open triangular shape opening. This tip is suitable, for example, for use in dispensing material along a corner.

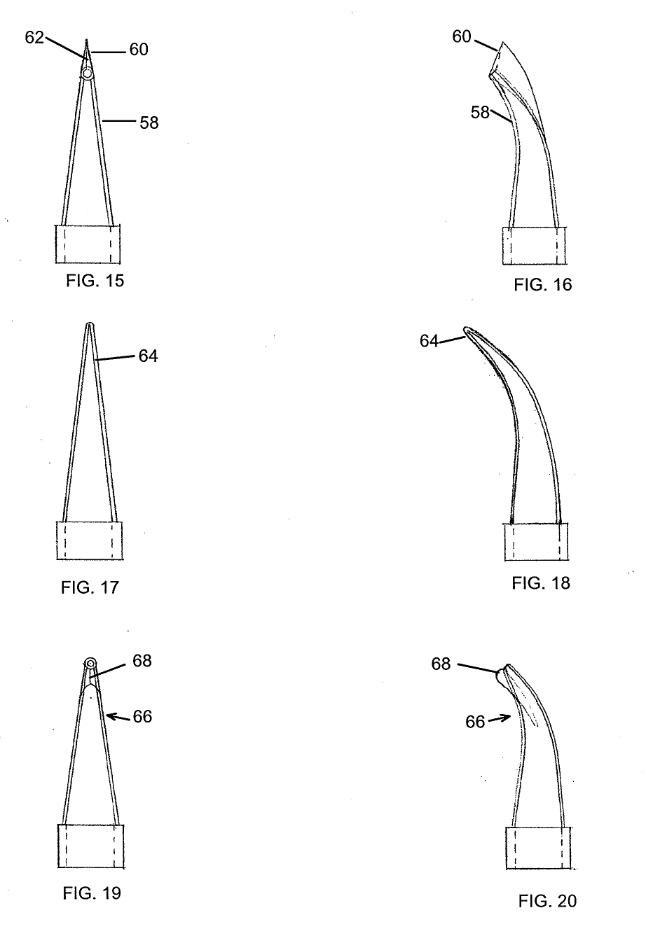

FIG. 15 and FIG. 16 are front and side views of a grouting tip or flashing tip 58. Above the round tip opening, which is pre-molded to that open configuration, is a split flare portion 60, which will flare apart along vertical line 62 (FIG. 15) when pushed, and return to its closed configuration when not pushed against a surface, for use in applying grout, for example.

FIG. 17 and FIG. 18 are front and side views of a long tip 64 adapted for multiple utility uses. This tip is preferably provided with a closed end so that the user can cut the tip to the desired angle and opening diameter, as needed by the particular material being applied and the user's application need.

FIG. 19 and FIG. 20 are front and side views of a siding tip 66 having a toe guide 68 for assisting in guiding the tip when moving it while applying material. This tip has a round opening that it pre-molded to the open configuration. This particular configuration is useful with particular styles of siding, such as fiber cement siding of the Hardie Plank brand style, for example.

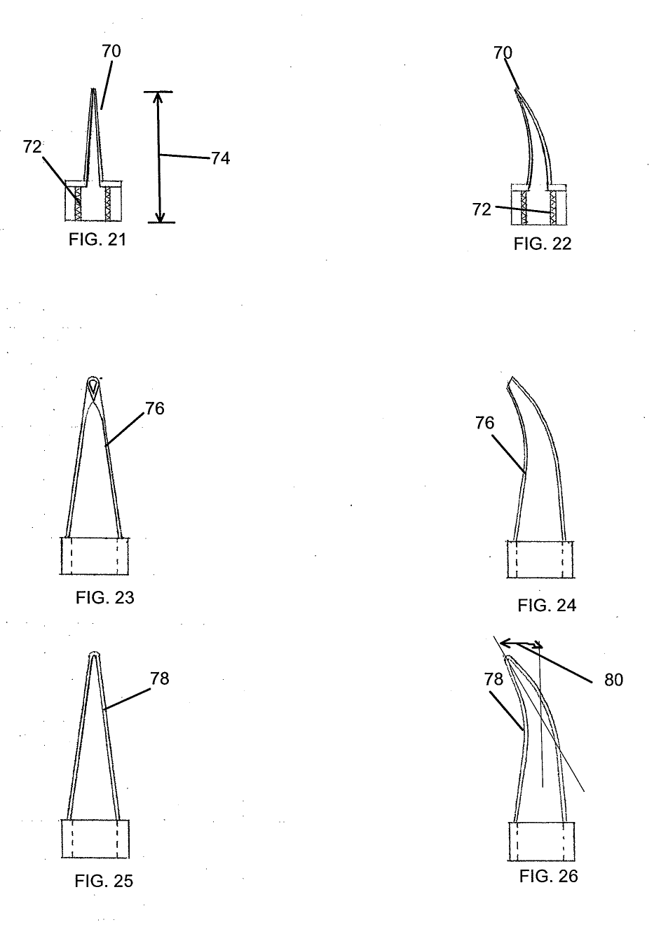

FIG. 21 and FIG. 22 are front and side views of a super glue tip 70 adapted for use with a super glue or cyanoacrylate glue style adhesive container. The tip 70 has interior threads 72 sized to be received by a typically super glue container, and has an exemplary height 74 of 1 and ⅜ths inch. The opening of this tip 70 is suitably pre-molded to the desired diameter, rather than requiring the user to cut the tip to a desired size.

FIG. 23 and FIG. 24 are front and side views of a dome tip 76, wherein the opening is pre-molded to the desired configuration, having a bottom portion that is v-shaped and a top portion that is curved or semi-circular.

FIG. 25 and FIG. 26 are front and side views of an angled tip 78. The angle 80 of the tip curve is suitably 25 degrees.

Accordingly, the above described tips allow caulking or other material to be applied in tight areas that would otherwise not be reachable (or would be difficult to reach) with a standard straight tip. The engagement of the tip attachment is such, however, that it may be removed as desired to allow continued use of the standard straight tip.

The tip provides a one piece tip in use, without requiring moving parts, without requiring manipulation of the tip to pull it out to a dispensing mode, for example.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A tip attachment for use in dispensing a product, comprising:
an elongate tip portion including a dispensing passage therein;
a base member adapted for attachment to a tip of a material dispensing vessel.
wherein said elongate tip portion and said base member have a mating relation for snap engagement with one another.

2. The tip attachment according to claim 1, wherein said elongate tip portion has a curved portion.

3. The tip attachment according to claim 2, wherein said curved portion is curved at an angle of approximately 25 to 30 degrees.

4. The tip attachment according to claim 1, wherein said base member includes a threaded portion having sharp cutting threads for threaded engagement with the tip of the material dispensing vessel.

5. The tip attachment according to claim 1, wherein said mating relation between said tip portion and said base member are accomplished by said tip portion comprising a tip circumferential notch and said base portion comprising a corresponding base circumferential notch, said tip and base notches adapted for mating engagement.

6. The tip attachment according to claim 5, wherein said tip portion further comprises a tab portion and said base portion comprises a corresponding mating slot for engagement with said tab portion.

6. The tip attachment according to claim 5, wherein said tip portion further comprises at least two tab portions and said base portion comprises at least two corresponding mating slots for engagement with said tab portions.

7. The tip attachment according to claim 6, wherein a first and second of said tab portions are spaced 180 degrees apart from one another.

8. The tip attachment according to claim 1, wherein said elongate tip portion is substantially circular in cross section.

9. The tip attachment according to claim 1, wherein said elongate tip portion is substantially triangular in cross section.

10. The tip attachment according to claim 1, wherein said elongate tip portion is substantially rectangular in cross section.

11. The tip attachment according to claim 1, wherein said elongate tip portion is substantially oval in cross section.

12. The tip attachment according to claim 1, wherein said elongate tip portion is substantially V shaped.

13. The tip attachment according to claim 1, wherein said elongate tip portion is substantially flat.

14. The tip attachment according to claim 1, wherein said elongate tip portion is substantially dome shaped.

15. The tip attachment according to claim 1, wherein said elongate tip portion is substantially chisel shaped.

16. The tip attachment according to claim 1, wherein said elongate tip portion comprises a double taper shape.

17. The tip attachment according to claim 1, wherein said elongate tip portion comprises a toe guide.

18. The tip attachment according to claim 1, wherein said elongate tip portion comprises a tip portion that flares outwardly under application pressure.

19. The tip attachment according to claim 1, wherein said elongate tip portion comprises an upper and lower fin portion adjacent an opening of the tip.

20. The tip attachment according to claim 1, wherein said elongate tip portion comprises a v-shaped end configuration.
